(19) United States
(12) Patent Application Publication
(10) Pub. No.: US 2008/0291943 A1
(43) Pub. Date: Nov. 27, 2008

(54) Method of Modifying the Power Spectral Density of a Telecommunications Line and an Adjustment Method Using That Method

(75) Inventors: Mohamed Tlich, Lannion (FR); Fabienne Moulin, Perros Guirec (FR); Ahmed Zeddam, Perros Guirec (FR)

Correspondence Address: OLIFF & BERRIDGE, PLC, P.O. BOX 320850, ALEXANDRIA, VA, 22320-4850, US

(73) Assignee: France Telecom, Paris (FR)

(21) Appl. No.: 11/664,939

(22) PCT Filed: Oct. 4, 2005
(86) PCT No.: PCT/FR05/02437

§ 371 Date: Jun. 22, 2007

(30) Foreign Application Priority Data
Oct. 7, 2004 (FR) 0410600

(51) Int. Cl. H04J 1/00

(52) U.S. Cl. 370/480

(57) ABSTRACT

The invention relates in particular to a method of modifying the spectral power density of a telecommunications line sending data from a sender terminal to a receiver terminal, the spectral power density being divided between a plurality of sub-bands of data transmission frequencies of the line. This method includes the following steps: an activation message is sent from the sender terminal to the receiver terminal and the reception of that activation message by the receiver terminal causes the sending of a message requesting modification of the spectral power density transmitted in a selected sub-band from the receiver terminal to the sender terminal.

The present invention relates to a method of modifying the spectral power density of a telecommunications line sending data from a sender terminal to a receiver terminal, the power spectral density being assigned to sub-bands of data transmission frequencies of the line.

The invention also relates to a method of adjusting the power spectral densities of a plurality of telecommunications lines using the above modification method.

Sending data from a sender terminal to a receiver terminal using a telecommunications line, with the sender terminal allocating a spectral power density to sub-bands of data transmission frequencies of the line, is known in the art.

There is already known in the art a method of modifying the spectral power density in which the data receiver terminal itself automatically initiates modification of the allocated spectral power density as a function of the power received and/or of the noise on the line estimated by the receiver terminal.

During that process, the receiver terminal sends the sender terminal a message requesting modification of the spectral power density assigned to at least one selected sub-band.

Since the receiver terminal initiates the modification, it can decode the data sent in each frequency sub-band at any time. Thus the modification of the spectral density does not generate transmission errors.

Nevertheless, the method described above does not enable the sender terminal to modify the spectral power density arbitrarily, independently of the power received and of the noise on the line estimated by the receiver terminal.

The invention aims to solve this problem by providing a method in which the sender terminal initiates the modification of the spectral power density without this modification leading to transmission errors.

To this end, the invention consists in a method of modifying the spectral power density of a telecommunications line sending data from a sender terminal to a receiver terminal, the spectral power density being allocated to sub-bands of data transmission frequencies of the line, which method includes a step of sending a message requesting modification of the transmitted spectral power density in a selected sub-band from the receiver terminal to the sender terminal and is characterized in that:
an activation message is sent from the sender terminal to the receiver terminal; and
reception of that activation message by the receiver terminal causes the sending of the message requesting modification of the transmitted spectral power density in the selected sub-band.

By means of the invention, the allocated spectral power density may be modified arbitrarily, as required. Moreover, as in the prior art method, the receiver terminal can decode the data sent in each frequency sub-band at any time without error.

A method according to the invention for modifying the spectral power density of a line may have one or more of the following features:
the activation message is sent in the form of a “vendor specific” type message via an overhead control channel conforming to at least one of the xDSL standards;
the message requesting modification of the transmitted spectral power density in the selected sub-band is sent in the form of a fast changeover request via an overhead control channel conforming to at least one of the xDSL standards;
the fast permutation request includes a data field containing an indicator of a predefined minimum level of modification of the spectral power density;
the data field includes a data bit, one value of this bit indicating the predefined minimum level, the other value of this bit indicating a reference level; and
the activation message is sent in the form of a fast permutation request via an overhead control channel conforming to at least one of the xDSL standards, includes a data field containing an indicator of a predefined minimum level of modification of the spectral power density, and further includes a “vendor specific” type message header.

The invention also consists in using a method of the invention to modify the spectral power density of a line to re-establish an initial spectral power density level.

The invention further consists in a method of adjusting spectral power densities of a plurality of telecommunications lines sending data, respective spectral power density being allocated to frequency sub-bands of each line sending data, characterized in that:
at least one “donor line” is selected, having capacity for sending data that is greater than a predetermined reference “donor capacity”;
at least one sub-band of that donor line is selected; and
the spectral power density allocated to the selected sub-band is reduced to a predefined minimum power level in that sub-band by the application of a modification method as described above.

An adjustment method of the invention exploits the property whereby reducing the spectral power density allocated to a sub-band of a line reduces stationary cross-talk noise induced by that sub-band on the other lines of the set. The effect of this noise reduction is automatically to increase the capacity of those other lines to send data.

Accordingly, selecting at least one line whose capacity for sending data is greater than a predetermined reference capacity and reducing the spectral power density of the selected line by extinguishing at least one of its sub-bands (i.e. by reducing the spectral power density allocated to that sub-band to a predefined minimum power level in that sub-band) increases the capacities of the other lines of the set without increasing the total spectral power density allocated to the set of lines.

The invention can be better understood with the assistance of the following description, given by way of example only and with reference to the appended drawings, in which:

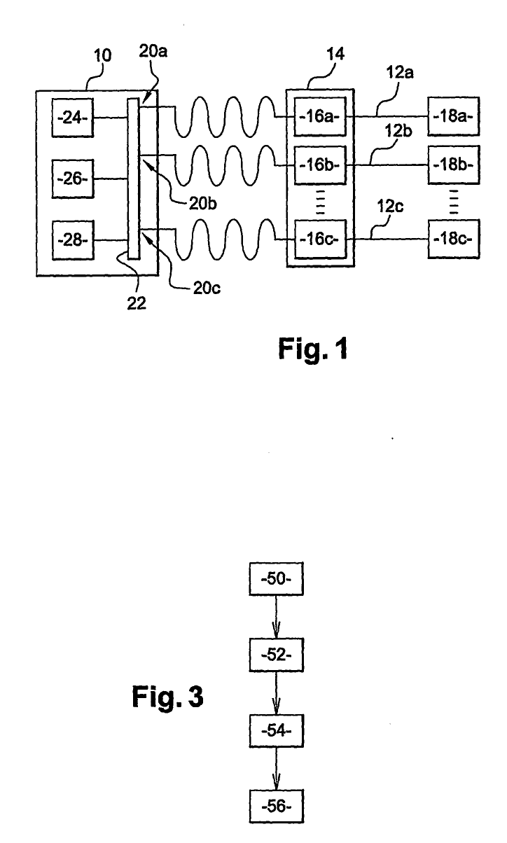

FIG. 1 represents diagrammatically the general structure of one embodiment of an adjustment device for implementing a modification method according to the invention;

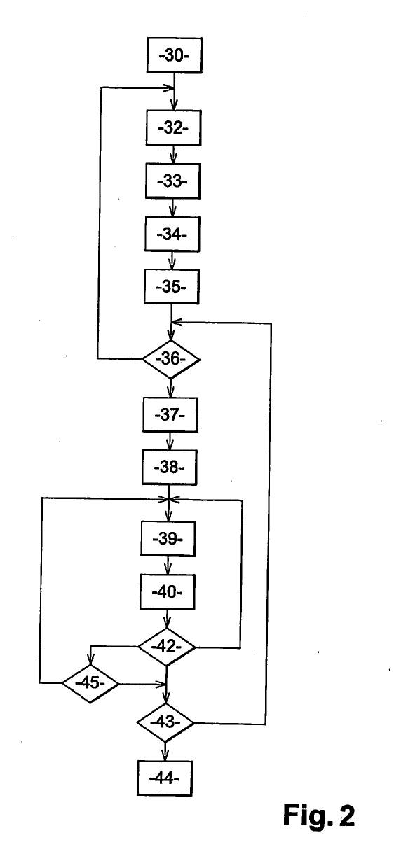

FIG. 2 represents the successive steps of one method of adjusting spectral power densities according to one possible embodiment of the invention; and

FIG. 3 represents the successive steps of a method of modifying spectral power densities according to one possible embodiment of the invention.

The adjustment device 10 represented in FIG. 1 adjusts the spectral power densities of a plurality of telecommunications lines 12a, 12b, . . . , 12c adapted to send data. These are xDSL-type lines, for example, for transmitting high bit rate signals.

Each line 12a, 12b, . . . , 12c is associated with a sender modem 16a, 16b, . . . , 16c. The sender modems 16a, 16b, . . . , 16c are housed in the same telephone central office 14 and are all connected to the adjustment device 10.

Each line 12a, 12b, . . . , 12c is also connected to a receiver terminal 18a, 18b, . . . , 18c.

The adjustment device 10 includes connection means 20a, 20b, . . . , 20c to the lines 12a, 12b, . . . , 12c. These connection means 20a, 20b, . . . , 20c are connected to a data transmission bus 22 of the adjustment device 10.

The adjustment device 10 further includes means 24 for extracting parameters specific to the lines 12a, 12b, . . . , 12c to which it is connected. Those parameters specific to the lines 12a, 12b, . . . , 12c are, for example, the required bit rate, the required minimum noise margin, the bit rate actually sent, the spectral power density or parameters relating to error correction techniques.

The parameter extraction means 24 are connected to the transmission bus 22. They can be activated at any time, even during a call on one or more of the lines 12a, 12b, . . . , 12c.

The adjustment device 10 also includes means 26 for selecting at least one line, referred to as the “donor line”, having capacity to send data that is greater than a predetermined reference capacity. These selection means 26 are also adapted to select at least one sub-band of this donor line.

In the example described, the capacity to send data is a maximum data bit rate that a line 12a, 12b, . . . , 12c can send with the spectral power density assigned to it, and the predetermined reference capacity is a bit rate equal to the maximum of the sum of a minimum bit rate required to provide at least one service to which a line 12a, 12b, . . . , 12c has a subscription with a predetermined bit rate margin plus a minimum bit rate guaranteed by the operator.

The adjustment device 10 finally includes means 28 for reducing the spectral power density assigned to the selected sub-band of the selected donor line to a predefined minimum spectral power density level in that sub-band. This reduction of its spectral power density is what is referred to herein as “extinguishing the sub-band”.

Note that the number of sub-bands of the donor line selected, and destined to be extinguished, must be such that the effective bit rate on this line remains above the required minimum bit rate, even after the spectral power density is reduced by the adjustment device 10. Adding the predetermined bit rate margin to the required minimum bit rate guarantees that this requirement is satisfied.

One function of the adjustment device 10 is to optimize the spectral power density assigned to each of the lines 12a, 12b, . . . , 12c as a function of the services to which each of those lines has a subscription and the resources available for all the lines.

The adjustment device 10 operates in accordance with a method that is described with reference to FIG. 2.

During a first or initialization step 30, there is determined for each line 12a, 12b, . . . , 12c a minimum bit rate required to provide the service(s) to which that line 12a, 12b, . . . , 12c has a subscription and that a client wishes to obtain.

During this initialization step 30, two reference capacities called the “donor capacity” and the “recipient capacity” are also determined for each line 12a, 12b, 12c, the recipient capacity being equal to the required nominal bit rate and the donor capacity being equal to the maximum of the sum of the minimum bit rate required with the predetermined bit rate margin plus a minimum bit rate guaranteed by the operator.

At the end of the initialization step 30, each line 12a, 12b, . . . , 12c has access to a maximum data bit rate that it can send with the spectral power density assigned to it. That maximum bit rate constitutes a capacity of the line 12a, 12b, . . . , 12c to send data.

There follows a step 32 of selecting donor lines and recipient lines. During this selection step 32, a first group of lines called “recipient lines” is selected having capacity to send data that is less than the recipient capacity. A second group of lines called “donor lines” is also selected having capacity to send data that is greater than the donor capacity.

A step 33 then verifies, for each recipient line of the first group, whether the following two conditions are satisfied:
if it was part of the second group of donor lines during a preceding execution of the adjustment method; and
if so, if at least one of its sub-bands was extinguished on that occasion by the reduction means 28.

If these two conditions are satisfied, the initial spectral power density level of the extinguished sub-bands of that recipient line before their extinction is re-established. There are two ways to do this:
using a modification method that is described with reference to FIG. 3; or
by re-establishing the spectral power density level at the initiative of the sender associated with that recipient line, without necessarily advising the corresponding receiver terminal.

If either or both of these two conditions is not satisfied or if, after the initial spectral power density level of the extinguished sub-bands has been re-established, that line still has a capacity for sending data less than the recipient capacity, the line is retained in the first group. If not, this line is withdrawn from the first group of recipient lines.

If one of the groups is empty, the selection step 32 is repeated until each of the groups includes at least one line. The adjustment method used by the device 10 requires at least one donor line to be in a position to reduce its capacity to send data to enable at least one recipient line to increase its capacity to send data.

There follows a step 34 of classification of the recipient lines. During this classification step 34, the recipient lines of the first group are classified according to two criteria, the first of which has priority over the second:
a predetermined level of privilege associated with each line; and
a value Δ associated with each line, equal to the difference between the capacity to send data and the recipient capacity.

Thus the recipient lines of the first group are first classified in decreasing order of their level of privilege. Then, if a plurality of lines have the same level of privilege, they are classified in increasing order of their value Δ. These lines are ordered in the first group.

This classification defines the order in which the recipient lines of the first group are processed in the remainder of the process. During a step 35, the first recipient line of the first group is selected.

A step 36 verifies whether the second group of lines, called “donor lines”, is empty. If it is empty, the process returns to the selection step 32 described above.

There follows a step 37 of selecting one or more sub-bands of the recipient line previously selected.

For example, the sub-band is selected in accordance with a criterion based on the level of crosstalk coupling between the lines in each sub-band of the selected recipient line. This gives preference to the sub-bands of the recipient line that have a high level of coupling with the other lines.

A normalized signal-to-noise ratio criterion may also be chosen.

In the example described, a plurality of sub-bands is selected, for example the twenty-five sub-bands of the selected recipient line with the highest coupling level or according to their normalized signal-to-noise ratio.

Depending on the criterion chosen, the selected sub-bands may themselves be classified.

In the remainder of the process, in order to process the selected recipient line more efficiently:
the selected sub-bands are grouped into batches, which accelerates processing whilst still addressing accurately the requirements of the recipient lines (a number Nsb of sub-bands per batch is defined);
each batch of sub-bands is assigned a certain number of donor lines, which number must not exceed a maximum number Nld;
this assignment is carried out batch of selected sub-bands by batch of selected sub-bands and in a plurality of iterations during each of which the same donor line can be assigned to only one batch;
the assignment of the donor lines to each batch of selected sub-bands of the recipient line may be repeated a maximum number N of times.

There follows a step 38 during which the selected sub-bands are grouped into batches of Nsb sub-bands. If Nsb has the value four, the twenty-five sub-bands are grouped into six batches each containing four sub-bands and one batch containing one sub-band.

A first cycle of assignment of the donor lines to each batch of sub-bands then begins.

To this end, there begins a first iteration, proceeding batch by batch, during which each donor line is assigned to a batch of sub-bands. During an iteration, a maximum number Nld of donor lines may be assigned to the same batch and the same donor line may be assigned to only one batch.

Thus a batch to which the subsequent steps 40 and 42 are applied is selected during a step 39.

The step 40 first of all verifies whether the selected batch is saturated, i.e. if a maximum number of bits per sub-band of the batch has been reached. If so, no donor line is assigned to this batch and another batch of the recipient line is selected for which the step 40 resumes from its beginning. If not, this selected batch is retained. The donor lines are then worked through to determine at most Nld donor lines that can be assigned to the selected batch. A donor line is assigned to this batch of sub-bands if the corresponding sub-bands in the donor line are not already all extinguished and if that donor line has not already been assigned to another batch in the current iteration. All the corresponding sub-bands of the donor line are then extinguished.

There follows the step 42 which measures the new capacity to send data of the selected recipient line. If that capacity is greater than the recipient capacity, that recipient line is considered to have been processed and is eliminated from the first group of recipient lines, and there follows a test step 43.

This step 43 verifies whether there remains at least one recipient line in the first group. If so, a new recipient line is selected and the process returns to the step 36. If not, there follows a step 44 that ends the process.

If the capacity for sending data measured during the step 42 is less than the recipient capacity, another batch of the recipient line is selected and the process returns to the step 40.

The steps 40 and 42 are repeated until no further donor lines can be assigned, for example because they have all been assigned already, or until there remain no further batches to be selected.

If donor lines can no longer be assigned, for example because they have all been assigned once already in the current iteration, the process returns to the step 39 to carry out a new iteration of assignment of donor lines, in addition to the assignments of the preceding iterations.

If there remain no further batches to be selected, there follows a step 45 which verifies whether at least one donor line has been assigned to a batch of sub-bands of the recipient line selected during the last iteration.

If at least one donor line has been assigned to a batch of sub-bands of the selected recipient line, and if the maximum number Nld of recipient lines assigned per batch of sub-bands has not been reached, the process resumes from the step 39, to perform a new iteration of assignment of donor lines.

If not, this indicates either that no donor line includes an unextinguished sub-band corresponding to the selected sub-bands of the recipient line or that the number Nld is reached for all the batches of sub-bands before the recipient line reaches its required minimum capacity.

If the number Nld has been reached for all the batches of sub-bands, the process can return to the step 39 to perform a new cycle of assignment of donor lines to each batch of selected sub-bands of the recipient line. A maximum number N of assignment cycles are preferably carried out, N being a predetermined number beyond which it is considered that further assignment of donor lines will not significantly increase the capacity of the recipient lines.

If the number N is reached, or if no donor line includes an unextinguished sub-band corresponding to the selected sub-bands of the recipient line, the recipient line is extracted from the first group of recipient lines and integrated into an ancillary group of recipient lines whose requirements cannot be satisfied, after which the process resumes at the step 43.

The adjustment method described above is optionally interrupted as soon as a new line becomes a donor line. Under such circumstances, that new line is integrated into the second group of donor lines, the lines of the ancillary group are re-integrated into the first group of recipient lines, and the process resumes at the step 34 of classifying the recipient lines.

Note that if there are no more donor or recipient lines at a given time the process is interrupted and returns to the step 32 of selecting donor and recipient lines.

FIG. 3 shows a method of the invention for modifying spectral power density that may be used in particular for re-establishing spectral power density levels in sub-bands in step 33 or for extinguishing sub-bands in step 40 of the FIG. 2 method. However, application of this method is not limited to the use of a method of adjusting spectral power densities such as that described above. It may be implemented independently, once extinguishing or re-establishing at least one sub-band of a telecommunications line is to be envisaged. Telecommunications line is used to cover any cable system that utilizes multicarrier modulation, for example electrical power line telecommunications (PLT) systems.

The spectral power density modification method shown in FIG. 3 includes the following steps:
the sender terminal (i.e. the sender modem) sends the receiver terminal an activation message; and
reception of that activation message by the receiver terminal causes the receiver terminal to send the sender terminal a message requesting reduction of the sending power spectral density in the selected sub-band.

This reduction process starts from the principle that, to change the send spectral power density without generating transmission errors, it is preferable for the change to be initiated by the receiver terminal.

More precisely, during a first step 50, one of the lines 12a, 12b, . . . , 12c for which at least one sub-band is to be extinguished is selected.

There follows a step 52 of sending an activation message in order for the receiver terminal associated with this line to send a message requesting reduction of the sending spectral power density assigned to the sub-bands to be extinguished. The activation message is sent from the sender modem 16a, 16b, . . . , 16c associated with the selected line 12a, 12b, . . . , 12c to the receiver terminal 18a, 18b, . . . , 18c of that line 12a, 12b, . . . , 12c.

The xDSL standards define an overhead control channel on which messages can circulate between the sender modem 16a, 16b, . . . , 16c and the receiver modem 18a, 18b, . . . , 18c. These standards also define the structure of these messages, and in particular the structure of a “vendor specific” message, whose size and content may be chosen at will. Accordingly, the activation message is preferably a “vendor specific” type message sent on the overhead control channel from the sender modem 16a, 16b, . . . , 16c to the receiver terminal 18a, 18b, . . . , 18c.

There follows a step 54 of sending the message requesting reduction of the sending spectral power density assigned to the sub-bands to be extinguished. That reduction request message is sent from the receiver terminal 18a, 18b, . . . , 18c to the sender modem 16a, 16b, . . . , 16c.

The xDSL standards define several types of messages intended to circulate on the overhead control channel and adapted to contain instructions for adjusting the sender modem 16a, 16b, . . . , 16c. One of these messages, called the “fast permutation request” message, is used to adjust the spectral power densities assigned to each sub-band by the sender modem 16a, 16b, . . . , 16c and is sent by the receiver terminal 18a, 18b, . . . , 18c.

The message requesting reduction of the send spectral power density preferably consists in a fast permutation request.

There finally follows a step 56 during which the sender modem 16a, 16b, . . . , 16c reduces the spectral power density of the sub-bands to be extinguished, in accordance with the instructions contained in the message sent by the receiver terminal 18a, 18b, . . . , 18c.

In the current versions of the xDSL standards, a fast permutation message may contain instructions for reducing the spectral power density allocated to a sub-band by a maximum of 4 dB, which may be insufficient to achieve the predefined minimum level in that sub-band, generally set at −14.5 dB (sub-band extinction level) relative to a reference level.

Accordingly, to extinguish a sub-band, the steps 54 and 56 may be repeated several times. Alternatively, a new data field may be defined in the fast permutation request, that field containing a direct indicator of a predefined minimum level, i.e. a level of −14.5 dB relative to the reference level.

The field may thus contain a data bit, one value of that bit indicating the predefined minimum level, the other value of that bit indicating the reference level.

It should be noted that, in the example described, the fast permutation message is sent in the form of a standard fast permutation message on the overhead control channel in accordance with at least one of the xDSL standards, to which the data field described above is added.

Moreover, the activation message is also sent in the form of a fast permutation request via the overhead control channel in accordance with at least one of the xDSL standards. It further includes a data field containing an indicator of a predefined minimum level of modification of the spectral power density and a “vendor specific” type message header.

It should be noted that the method described above may be used to re-establish the initial spectral power density level of sub-bands, for example for re-establishing spectral power density levels in the step 33 of the FIG. 2 method. Thus it is possible to use the new data field in the fast permutation request, that field then containing an initial level indicator.

A method according to the invention can be executed at any time, including during use of the lines 12a, 12b, . . . , 12c to provide services to which they have a subscription. It can therefore be used to adjust the capacities of the lines in real time.

It is clear that the adjustment method and device described above enable optimum overall management of the capacities to send data of a set of lines.

1-8. (canceled)

9. A method of modifying the spectral power density of a telecommunication line sending data from a sender terminal to a receiver terminal, the spectral power density being allocated to sub-bands of data transmission frequencies of the line, which method includes a step of sending a message requesting modification of the transmitted spectral power density in a selected sub-band from the receiver terminal to the sender terminal; and
an activation message is sent from the sender terminal to the receiver terminal; and
reception of that activation message by the receiver terminal causes the sending of the message requesting modification of the transmitted spectral power density in the selected sub-band.

10. A method according to claim 9 for modifying the spectral power density of a line, wherein the activation message is sent in the form of a “vendor specific” type message via an overhead control channel conforming to at least one of the xDSL standards.

11. A method according to claim 9 for modifying the spectral power density of a line, wherein the message requesting modification of the transmitted spectral power density in the selected sub-band is sent in the form of a fast changeover request via an overhead control channel conforming to at least one of the xDSL standards.

12. A method according to claim 11 for modifying the spectral power density of a line, wherein the fast permutation request includes a data field containing an indicator of a predefined minimum level of modification of the spectral power density.

13. A method according to claim 12 for modifying the spectral power density of a line, wherein the data field includes a data bit, one value of this bit indicating the predefined minimum level, the other value of this bit indicating a reference level.

14. A method according to claim 12 for modifying the spectral power density of a line, wherein the activation message is sent in the form of a fast permutation request via an overhead control channel conforming to at least one of the xDSL standards, includes a data field containing an indicator of a predefined minimum level of modification of the spectral power density, and further includes a “vendor specific” type message header.

15. A method for re-establishing an initial spectral power density level comprising applying the method according to claim 9 for modifying the spectral power density of a line.

16. A method of adjusting spectral power densities of a plurality of telecommunication lines sending data, a spectral power density being allocated to frequency sub-bands of each line sending data, wherein:
at least “one donor” line is selected, having capacity for sending data that is greater than a predetermined reference “donor capacity”;
at least one sub-band of that donor line is selected; and
the spectral power density allocated to the selected sub-band is reduced to a predefined minimum power level in that sub-band by the application of a modification method according to claim 9.

17. A signal intended to be transmitted between a sender terminal and a receiver terminal interconnected by a telecommunication line sending data in order to modify the spectral power density of said line sending data, wherein said signal carries an activation message comprising a field comprising an indicator of a predefined minimum level of modification of the spectral power density of said line sending data.

18. A signal intended to be transmitted between a receiver terminal and a sender terminal interconnected by a telecommunication line sending data in order to modify the spectral power density of said line sending data, wherein said signal carries a message requesting modification of the spectral power density of said line sending data, said modification request message comprising a field comprising an indicator of a predefined minimum level of modification of the spectral power density of said line sending data.

19. A data sender terminal intended to be connected to a telecommunication line sending data, said sender terminal including means for receiving a message requesting modification of a spectral power density of said line sending data, and means for sending an activation message intended to cause the sending of said modification request message.

20. A receiver terminal intended to be connected to a telecommunication line sending data, said receiver terminal including means for sending a message requesting modification of a spectral power density of said line sending data, and means for receiving an activation message intended to cause the sending of said modification request message.
